(19) United States
(12) Patent Application Publication
(10) Pub. No.: US 2009/0191382 A1
(43) Pub. Date: Jul. 30, 2009

(54) FLOOR MAT AND PROCESS FOR MANUFACTURING SAME

(75) Inventor: Keiji Usuda, Shiga (JP)

Correspondence Address: SUGHRUE MION, PLLC, 2100 PENNSYLVANIA AVENUE, N.W., SUITE 800, WASHINGTON, DC, 20037, US

(73) Assignee: Japan Vilene Company, Ltd., Tokyo (JP)

(21) Appl. No.: 12/343,560

(22) Filed: Dec. 24, 2008

Related U.S. Application Data
(60) Provisional application No. 61/017,332, filed on Dec. 28, 2007.

(51) Int. Cl. B32B 5/22; B32B 37/02

(52) U.S. Cl. 428/172; 428/98; 156/196

(57) ABSTRACT

A floor mat (10) consisting of two or more porous material layers (1, 2, 3), wherein a boundary surface between a porous material layer constituting a reverse side layer (1) and another porous material layer (2) adjacent to the porous material layer is composed of an adhesive surface and a non-adhesive surface, the non-adhesive surface is a non-contact surface, and an independent space (4) is formed between the porous material layer constituting the reverse side layer and the porous material layer adjacent thereto, is disclosed.

### BACKGROUND OF THE INVENTION

1. Field of the Invention

The present invention relates to a floor mat, particularly a floor mat for an automobile, and a process for manufacturing the same.

2. Description of the Related Art

Hitherto, a floor mat for an automobile is laid over a carpet floor in an automobile so as to prevent an adherence and staining of the carpet floor by dirt on shoes, such as soil, sand, mud, gravel, rainwater, or muddy water, or drinks spilled by the driver or a passenger. In an initial floor mat, because priority was given to water resistance, air permeability of the floor mat as a whole was low, and as a result, the floor mat exhibited a poor sound absorbing property.

To enhance a sound absorbing property of a floor mat, for example, patent reference 1 discloses that a sound absorbing property can be enhanced by using a bulky-nonwoven fabric as the backside of a floor mat (for example, paragraphs [0034] and [0044], and Example 6).

To enhance a sound absorbing property along with a slip resistant property, patent reference 2 (for example, claim 1) discloses a sound absorbing mat in which a mat body having air permeability is arranged on the upper face of an underlying sheet made from a soft material, having a number of venting holes, a number of anti-slip projections on its lower face, and a number of space-forming projections on its upper face, and patent reference 3 (for example, claim 1) discloses a mat for an automobile in which a nonwoven fabric as a reverse side layer is integrated with an upper surface layer by a heat-adhesive resin linearly arranged in parallel at predetermined intervals.

Patent reference 4 (claim 1), patent reference 5 (claim 1), patent reference 6 (claims), and patent reference 7 (claim 1) do not refer to a sound absorbing property, but disclose a use of a nonwoven fabric as a reverse side layer, and thus, mats disclosed in these patent references can be expected to have a good sound absorbing property.

[patent reference 1] Japanese Unexamined Patent Publication (Kokai) No. 2003-40018
[patent reference 2] Japanese Unexamined Patent Publication (Kokai) No. 2006-44644
[patent reference 3] Japanese Registered Utility Model Publication No. 3131839
[patent reference 4] Japanese Unexamined Patent Publication (Kokai) No. 2002-4163
[patent reference 5] Japanese Unexamined Patent Publication (Kokai) No. 2001-260734
[patent reference 6] Japanese Unexamined Patent Publication (Kokai) No. 2000-185586
[patent reference 7] Japanese Unexamined Patent Publication (Kokai) No. 2000-83795

### SUMMARY OF THE INVENTION

Under the circumstances, an object of the present invention is to provide a floor mat having a more excellent sound absorbing property.

The problem may be solved by a floor mat of the present invention, characterized by consisting of two or more porous material layers, wherein a boundary surface between a porous material layer constituting a reverse side layer and another porous material layer adjacent to the porous material layer is composed of an adhesive surface and a non-adhesive surface, the non-adhesive surface is a non-contact surface, and an independent space is formed between the porous material layer constituting the reverse side layer and the porous material layer adjacent thereto.

This floor mat can be produced by a process of the present invention, for manufacturing the above floor mat, comprising the steps of:

compressing a porous material between a die having a convex portion to form the independent space, and a flat plane, to thereby obtain a porous material having a concave portion, and
integrating the obtained porous material having a concave portion with another porous material by adhesion of part of a surface to be contacted.

In a preferred embodiment of the floor mat of the present invention, the floor mat has a depression at the reverse side of the porous material layer constituting the reverse side layer.

This floor mat can be produced by a process of the present invention, for manufacturing the above floor mat, comprising the steps of:

compressing a porous material between a die having a convex portion to form the independent space, and a die having a convex portion to form the depression at the reverse side of the reverse side layer, to thereby obtain a porous material for the reverse side layer having a concave portion and the depression, and
integrating the obtained porous material for the reverse side layer with another porous material by adhesion of part of a surface to be contacted.

In the floor mat of the present invention, the boundary surface between the porous material layer constituting the reverse side layer and another porous material layer adjacent to the porous material layer contains one or more non-adhesive surfaces, and therefore, the floor mat has an excellent sound absorbing property, because air permeability is imparted by the non-adhesive surfaces. In the floor mat of the present invention, the independent spaces between the reverse side layer and the reverse-side-adjacent layer can further enhance the sound absorption effect, because resonance occurs within the spaces. In the preferred embodiment of the present invention, having one or more depressions at the reverse side of the reverse side layer, when the floor mat is placed on a floor, another independent spaces are formed from the surface of the floor and the depressions, and therefore, the sound absorption effect can be enhanced, because resonance occurs within the spaces.

### BRIEF DESCRIPTION OF THE DRAWINGS

FIG. 1 is a schematic sectional view of an embodiment of the floor mat according to the present invention.

FIG. 2 is a schematic partial sectional view of part of the floor mat shown in FIG. 1, wherein constituent components are separated from each other.

FIG. 3 is a graph showing a result (normal incidence sound absorption coefficient) of a test for sound absorption.

FIG. 4 illustrates various lattice patterns which may be used in an islands-in-sea arrangement.

FIG. 5 is a schematic plane view showing the structure of a resin sheet used in Comparative Examples 2 and 3.

### REFERENCE SIGNS LIST

10 . . . floor mat; 1 . . . reverse side layer; 2 . . . layer adjacent to reverse side layer; 3 . . . carpet layer; 4 . . . independent space; 11 . . . contact surface; 12 . . . inner curvature surface; 13 . . . dome-shaped convex portion; 14 . . . depression; 21 . . . contact surface; 22 . . . non-contact surface.

### DETAILED DESCRIPTION OF THE INVENTION

The floor mat of the present invention consists of at least two porous material layers, and exhibits an improved sound absorption property by adhering a porous material layer constituting the reverse side layer to another porous material layer adjacent to the porous material layer, not at the whole of the boundary surface of the two porous material layers, but only at part of the boundary surface. The sound absorption property can be further improved by forming one or more independent spaces at the boundary surface and, in addition, by forming one or more depressions at the reverse side of the reverse side layer.

Porous material layers constituting the floor mat of the present invention are not particularly limited, so long as they have a porous structure and may be generally used as a floor mat. Examples of the porous material layers include a carpet, a nonwoven fabric (for example, a needle-punched nonwoven fabric, a stitch-bonded nonwoven fabric, a thermal bonded nonwoven fabric, or a spunbonded nonwoven fabric), a woven fabric, a knitted fabric, a foam (for example, a mechanically foamed foam or a chemically foamed foam), a porous film, a microporous film, a crushed rubber laminate prepared by laminating crushed rubbers and adhering them by an adhesive, and a fiber aggregate (for example, recovered wool or a felt).

Among these porous material layers, the carpet layer has an excellent decorative effect, and can provide the driver or a passenger with a comfortable driving effect. Therefore, it is preferable to use the carpet layer as the porous material layer constituting an upper surface layer of the floor mat for an automobile. The carpet is not particularly limited, and examples of the carpet include a tufted carpet, a needle-punched carpet, a hand-knotted carpet, a hooked rug, a wilton carpet, and an axminster carpet.

The porous material layer constituting the reverse side layer is preferably composed of a nonwoven fabric, and heat-adhesive fibers account for preferably 30% or more (more preferably 50% or more, most preferably 70% or more) to impart an excellent moldability. In this regard, the reverse side layer may be formed of a nonwoven fabric having a two-layer structure in which an increased amount of the heat-adhesive fibers is contained in the layer located at the reverse side, so as to enhance a form stability of the independent spaces. Further, when the layer located at the reverse side contains fine fibers, a slip resistance property may be improved.

When the porous material layer constituting the reverse side layer is composed of a nonwoven fabric, the nonwoven fabric preferably contains fibers having a fineness of 1.5 denier or more to impart air permeability and improve stiffness. In this regard, the type of the fiber is not particularly limited, and may be, for example, a polyester based fiber or a polypropylene based fiber.

In the floor mat of the present invention, the adhesion of the porous material layer constituting the reverse side layer to the porous material layer adjacent to the porous material layer (hereinafter referred to as reverse-side-adjacent layer) is carried out, only at part of areas of the boundary surface of the reverse side layer and the reverse-side-adjacent layer, and thus, the boundary surface is composed of an adhesive surface(s) and a non-adhesive surface(s). In this regard, when the porous material layers are formed of, for example, nonwoven fabrics, and two nonwoven fabric layers are adhered to each other, fibers constituting the nonwoven fabrics are microscopically adhered to each other at their contacting points, but the terms “contact surface” and “non-contact surface” as used herein are macroscopic concepts. More particularly, in the floor mat of the present invention, the reverse side layer is adhered to and integrated with the reverse-side-adjacent layer, only at part of a surface to be contacted, and thus, the adhesive surfaces, in which the reverse side layer is adhered to the reverse-side-adjacent layer, and the non-adhesive surfaces, in which the reverse side layer is not adhered to the reverse-side-adjacent layer, are formed. The boundary surface consisting of the adhesive surfaces and the non-adhesive surfaces exhibits an excellent sound absorbing property, because air permeability is imparted by the non-adhesive surfaces. In the present invention, only part of a surface to be contacted can be adhered, for example, by applying an adhesive only to part of the surface to be contacted, or by applying an adhesive to the whole of the surface to be contacted and activating its adhesive action only at part of the surface to be contacted.

An adhesive which may be generally used for adhering porous material layers to each other in the production of a floor mat can be used in the present invention. Examples of the adhesive include a hot-melt resin, a fiber web having a low melting point, a powder resin (for example, polyethylene or the like), and an emulsion-type adhesive.

A pattern of the adhesive surfaces and the non-adhesive surfaces is not particularly limited, so long as a peeling of the reverse side layer from the reverse-side-adjacent layer does not occur when using the floor mat, and a sufficient sound absorbing property can be obtained. Examples of the pattern include an islands-in-sea pattern, a checkered pattern, and a hound's-tooth check pattern. In the islands-in-sea pattern, islands portions may be arranged randomly or regularly. For example, island portions may be regularly arranged at each intersection 20 of various grid patterns as shown in FIG. 4, at regular intervals in the longitudinal and transverse directions [FIG. 4(A)], or at regular intervals in the right oblique direction and/or in the left oblique direction [FIG. 4(B)]. Further, in the islands-in-sea pattern, independent spaces, in which a contact surface is the sea portion and non-contact surfaces are the islands portions, may be formed between the reverse side layer and the reverse-side-adjacent layer.

In the floor mat of the present invention, the non-adhesive surfaces are non-contact adhesive surfaces in which one or more independent spaces are formed between the reverse side layer and the reverse-side-adjacent layer. The term “independent space” as used herein means a space which is discontinuous with the surroundings and can be macroscopically recognized as a definite space. In other words, when the porous material layers are formed of, for example, nonwoven fabrics, there are many microscopic spaces between constituent fibers, but the term “independent space” does not mean such microscopic spaces. The independent space which may be formed in the floor mat of the present invention is preferably 1 mm or more, more preferably 2 mm or more, with respect to the distance between the reverse side layer and the reverse-side-adjacent layer.

The independent spaces between the reverse side layer and the reverse-side-adjacent layer can enhance the sound absorption effect, because resonance occurs within the spaces.

The floor mat of the present invention having one or more independent spaces between the reverse side layer and the reverse-side-adjacent layer can be produced by, for example, using a combination of a die having one or more convex portions to form one or more corresponding independent spaces, and a flat plane. More particularly, a porous material may be compressed between the die having one or more convex portions to form the corresponding independent spaces and the flat plane to thereby obtain a porous material having one or more concave portions, and the obtained porous material having one or more concave portions may be integrated with another porous material by adhesion of part of a surface to be contacted so that the concave portions are arranged inside to produce the desired floor mat. In this process, the porous material which forms the concave portions may be the reverse side layer or the reverse-side-adjacent layer, or both layers. For example, when the porous material forming the concave portions is the reverse side layer, the concave portions may be faced with the reverse-side-adjacent layer to integrate the layers. Alternatively, when the porous material forming the concave portions is the reverse-side-adjacent layer, the concave portions may be faced with the reverse side layer to integrate the layers.

The floor mat of the present invention may have one or more depressions at the reverse side of the reverse side layer, in addition to the independent spaces. In the floor mat having such depressions in the reverse side layer, when the floor mat is placed on a floor, another independent spaces are formed from the surface of the floor and the depressions, and therefore, a sound absorption effect can be enhanced due to occurrence of resonance within the spaces. The depressions may be arranged not only at any portions other than the independent spaces formed between the reverse side layer and the reverse-side-adjacent layer, but also, instead thereof or in addition thereto, at the top of the independent spaces. The depression preferably has a depth of 2 to 10 mm.

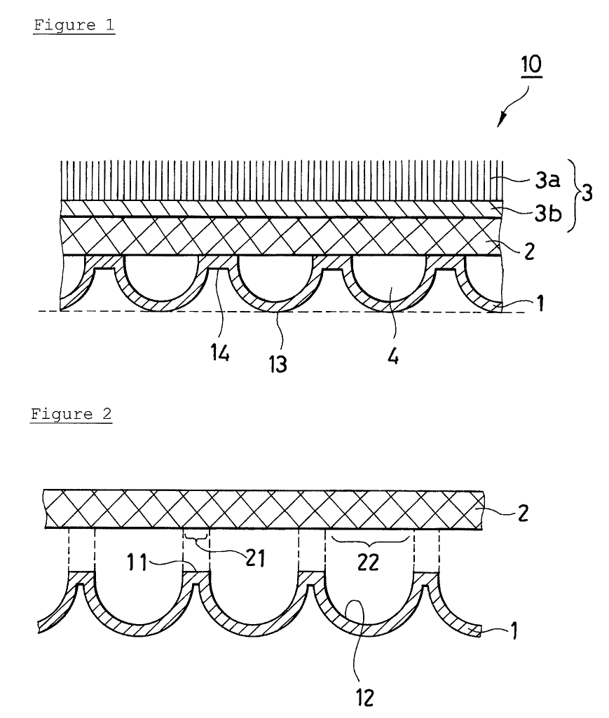

An embodiment of the floor mat of the present invention having the independent spaces between the reverse side layer and the reverse-side-adjacent layer and depressions at the reverse side is shown in FIGS. 1 and 2. FIG. 1 is a schematic sectional view of an embodiment of the floor mat according to the present invention, and FIG. 2 is a schematic partial sectional view of part of the floor mat shown in FIG. 1, wherein constituent components are separated from each other.

The floor mat 10 shown in FIG. 1 is composed of a reverse side layer 1, a reverse-side-adjacent layer 2, and a carpet layer 3, from the bottom to the top. The carpet layer 3 is composed of a pile layer 3A and a substrate layer 3B. The dot line shown in FIG. 1 indicates a virtual surface on which a floor carpet is placed (hereinafter referred to as the placing surface).

The reverse side layer 1 has a number of hemispherical convex portions 13 which project toward the direction of the reverse side (i.e., the contact surface to the placing surface), and a depression 14 arranged between the convex portions. The pattern of the reverse side layer, observed from the reverse side, is an islands-in-sea pattern in which the depression 14 is a sea and the hemispherical convex portions are islands [the hemispherical convex portions (islands) are arranged at each intersection of a grid pattern].

The reverse side layer 1 is adhered to the reverse-side-adjacent layer 2 at a contact surface 11 of the reverse side layer and a contact surface 21 of the reverse-side-adjacent layer 2. Hemispherical independent spaces 4 are formed from inner curvature surfaces 12 of the reverse side layer and non-contact surfaces 22 of the reverse-side-adjacent layer 2.

The floor mat (for example, the floor mat shown in FIG. 1) of the present invention having one or more independent spaces between the reverse side layer and the reverse-side-adjacent layer and one or more depressions at the reverse side can be produced by, for example, using a combination of a die having one or more convex portions to form one or more corresponding independent spaces, and a die having one or more convex portions to form one or more corresponding depressions at the reverse side of the reverse side layer (for example, a pair of male and female plane or roll dies). More particularly, a porous material may be compressed between these dies to thereby obtain a porous material for the reverse side layer having one or more concave portions and one or more depressions, and the obtained porous material for the reverse side layer may be integrated with another porous material for the reverse-side-adjacent layer by adhesion of part of a surface to be contacted so that the concave portions are arranged inside to produce the desired floor mat.

In this regard, the top of each projection of the male die is preferably flat, so that the male die is easily put into the female die. Further, it is preferable to carry out a cold-press after heating.

Furthermore, a form stability of the convex can be enhanced by adding one or more resins to the reverse side layer at the reverse side. Examples of such resins include an acrylic resin, a styrene-butadiene copolymer, chloroprene, a nitrile rubber, polyvinyl alcohol, and an ethylene-vinyl acetate copolymer. These resins may be added by, for example, a dispersion of powder, or an application (such as impregnation, coating, or spraying) of an emulsion.

The convex portion (at the foot) formed by arranging the depression(s) at the reverse side of the reverse side layer has preferably an area of 7 mm² or more, and an area of 314 mm² or less. The top of the convex portion may be hemispherical or plane, or may have one or more depressions. The convex portion has a height of preferably 2 to 10 mm, more preferably 3 to 8 mm, most preferably 4 to 6 mm. The shape of the convex portion is not particularly limited, but the shape at the foot of the convex portion may be, for example, circular, oval, elliptical, hemispherical, triangle, quadrangle (trapezoid, parallelogram, rectangle, or the like) or polygonal, and the shape of the convex portion may be, for example, column, prism, cone, pyramid, truncated cone or pyramid, or wavy pleated shape.

### EXAMPLES

The present invention now will be further illustrated by, but is by no means limited to, the following Examples.

### Example 1

### Production of Floor Mat (1)

As a carpet layer (an upper surface layer), a tufted carpet (length of pile=8 mm, ⅛ gauge, area density=750 g/m²) composed of polyester fibers was provided. The reverse side of the carpet was coated with a styrene-butadiene rubber latex (dry weight: 240 g/m²) so as to avoid dropping of polyester fibers, and a substrate layer (area density=120 g/m²) composed of polyester fibers was contained in the carpet.

As a substrate for a reverse side layer, a felt (area density=400 g/m²) was impregnated with a foamed emulsion of vinyl acetate (area density=100 g/m²) from one side of the felt, and dried, and polyethylene powder (particle size: 80 to 180 μm) was dispersed (50 g/m²) onto the impregnated surface, and heated at 140° C. for 1 minute to adhere polyethylene powder to the felt by fusion. In this regard, the felt was a nonwoven fabric consisting of 100% of polyester fibers of 6.6 dex, and prepared by carding the polyester fibers to form a cross-lay web, and then needle-punching the web with needles (#40S, density: 300 needles/cm²).

Next, the resulting substrate for a reverse side layer was heated at 240° C. for 1 minute in a circulating heater, and cold-pressed by a pair of dies (male and female dies) so as to form convex portions at the polyethylene-powder-adhered surface. In this step, a die [diameter of convex portion (at the foot): 9 mm, height of convex portion: 5 mm, distance between the centers of convex portions: 10 mm] capable of forming hemispherical convex portions arranged at regular intervals in the longitudinal and transverse directions (i.e., arranged at each intersection of a grid pattern) was used as the male die, and a die having gaps of approximately 0.1 mm with respect to all directions of each convex portion of the male die was used as the female die.

Polyethylene powder (particle size: 80 to 180 μm) was dispersed (100 g/m²) on the reverse side of the carpet, and heated at 140° C. for 1 minute in a circulating heater to fuse the powder.

Next, the polyethylene-powder-adhered surface of the molded substrate for a reverse side layer was mounted on a female die having the same shape as above, and then, the heated carpet was placed on the substrate. A cold-press was carried out from the carpet side with a flat plane to produce a floor mat.

### Example 2

### Production of Floor Mat (2)

As a carpet layer (an upper surface layer), the same carpet as that used in Example 1 was provided.

As a substrate for a reverse side layer, a felt (area density=175 g/m²) was impregnated with a foamed emulsion of vinyl acetate (area density=25 g/m²) from one side of the felt, and dried. The felt was prepared by the method described in Example 1.

Next, the substrate for a reverse side layer was heated at 240° C. for 1 minute in a circulating heater, and cold-pressed by a pair of dies (male and female dies) the same as those used in Example 1 so as to form convex portions at the vinyl-acetate-emulsion-adhered surface.

Polyethylene powder (particle size: 80 to 180 μm) was dispersed (100 g/m²) on the reverse side of the carpet, and heated at 140° C. for 1 minute in a circulating heater to fuse the powder.

Next, the vinyl-acetate-emulsion-adhered surface of the molded substrate for a reverse side layer was mounted on a female die having the same shape as above, and then, the heated carpet was placed on the substrate. A cold-press was carried out from the carpet side with a flat plane to produce a floor mat.

### Example 3

### Production of Floor Mat (3)

A depression formed at the reverse side of the floor mat produced in Example 1 was filled (16 g per area of 10 cm×10 cm) with opened polyester fibers (fineness: 4.4 dtex, fiber length: 51 mm) to produce a floor mat in which the surface at the reverse side was flat.

### Comparative Example 1

### Production of Floor Mat for Comparison (1)

As a carpet layer (an upper surface layer), a tufted carpet (area density=1360 g/m²) composed of polyester fibers was provided. The reverse side of the carpet was coated with a styrene-butadiene rubber latex (dry weight: 240 g/m²), and a primary substrate (area density=120 g/m²) composed of polyester fibers was contained in the carpet.

Polyester fibers (fineness: 4.4 dtex) and polyester fibers (fineness: 17 dtex) were carded to form a cross-lay web, and then the resulting web was needle-punched with needles (#40S, density of needle-punching: 300 needles/cm²) to form a nonwoven fabric (area density=400 g/m²).

Next, 1,2-polybutadien (manufactured by JSR, RB830), a styrene-butadiene block polymer (manufactured by JSR, TR1600), and a blowing agent (Sodium hydrogencarbonate, manufactured by Eiwa Chemical Ind. Co., Ltd., CELLBORN SC-855) were mixed at a ratio by weight of 60:40:4, and a mixture was extruded from an extruder (temperature of cylinder: 120 to 170° C., temperature of die: 170 to 180° C.), and supplied between the carpet and the nonwoven fabric to produced a multi-layered floor mat for comparison (area density of the intermediate layer: 300 g/m²).

### Comparative Example 2

### Production of Floor Mat for Comparison (2)

As a carpet layer (an upper surface layer) and a felt (area density=400 g/m²), the carpet and the felt the same as those used in Example 1, respectively, were provided.

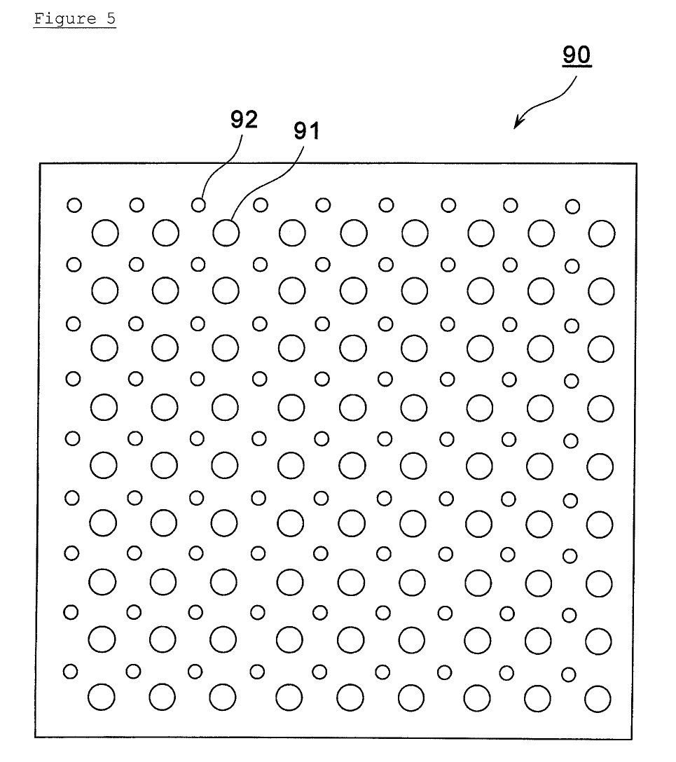

As an SBS resin sheet, a resin sheet 90 (thickness: 1.3 mm, 10 cm×10 cm), as shown in FIG. 5, having openings 91 (total number: 81) having a diameter of 4 mm arranged at each point of a grid pattern and projections 92 (total number: 81) having a diameter of 3 mm arranged at each point of a grid pattern was provided. In this regard, the projections 92 projected from both sides (i.e., the upper surface side and the reverse side) of the resin sheet, and the height (distance between the base of the resin sheet and the top of the projection) of each projection was 3 mm at both sides. The total area of the openings was 10.1 cm² (10.1% of the resin sheet).

A spray adhesive [3M Spray Adhesive 99 (Sumitomo 3M Limited)] was applied (mass per unit area: 100 g/m²) on the carpet layer, the carpet layer was layered with the felt, and the whole was dried and compressed for a day with a load of 2 kg/cm² to obtain a laminate.

Next, the resin sheet was layered with the laminate at the felt side of the laminate to produce a floor mat. In this regard, the laminate was brought into contact with the resin sheet, but was not adhered (i.e., not bound) to the resin sheet.

### Comparative Example 3

### Production of Floor Mat for Comparison (3)

The procedures described in Comparative Example 2 were repeated, except that a felt having an area density of 180 g/m² was used, to produce a floor mat.

### Example 4

### Measurement of Air Permeability

The floor mats of the present invention produced in Examples 1 to 3 and the floor mats for comparison produced in Comparative Examples 1 to 3 were used to measure the air permeability (unit: mL/cm²/sec) in accordance with a Frazier method [JIS L 1096: 1999 (8.27.1, A method)].

The result is shown in Table 1.

TABLE 1

| | Air permeability |
|---|---|
| Example 1 | 21.9 |
| Example 2 | 12.4 |
| Example 3 | 21.9 |
| Comparative Example 1 | 0.50 |
| Comparative Example 2 | 0.60 |
| Comparative Example 3 | 0.42 |

### Example 5

### Evaluation of Sound Absorption

The floor mats of the present invention produced in Examples 1 to 3 and the floor mats for comparison produced in Comparative Examples 1 to 3 were used to evaluate the sound absorption.

More particularly, a measuring apparatus of Brüel & Kjær was used to measure the sound absorption coefficient of each floor mat in accordance with ISO 10534-2 “Acoustics—Determination of sound absorption coefficient and impedance in impedance tubes—, part 2: transfer-Function method”.

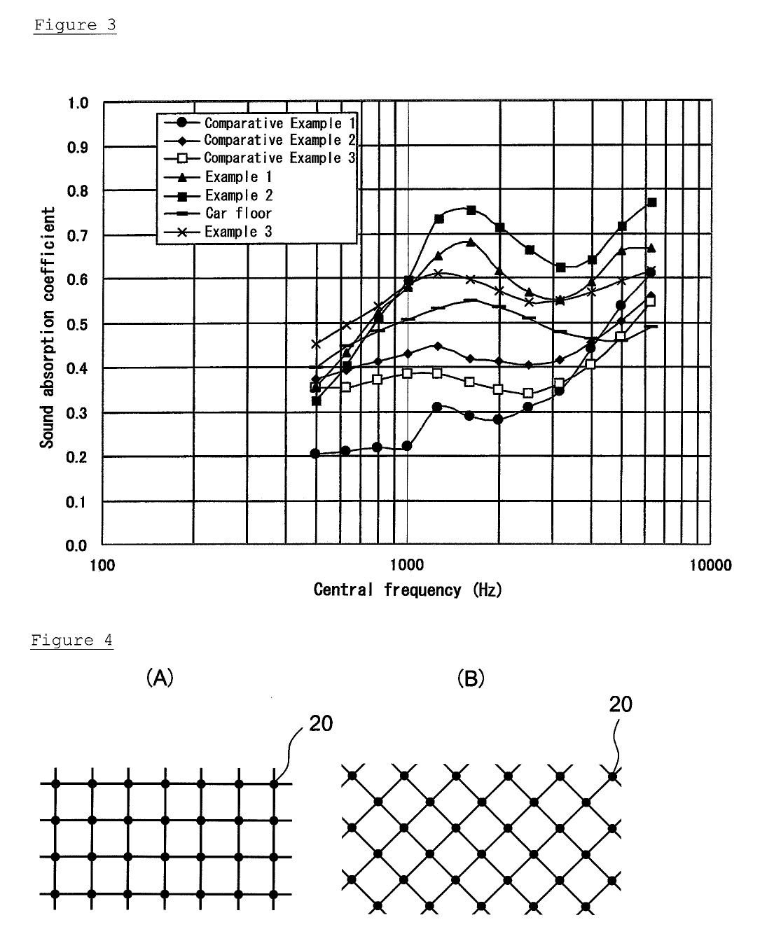

The result of a normal incidence sound absorption coefficient (each sample to be evaluated was placed on a floor material for an automobile, and measured) is shown in FIG. 3, and the result of an average sound absorption Hz frequency range) (each sample to be evaluated was placed on a floor material for an automobile, and measured) is shown in Table 2.

TABLE 2

| | average sound absorption |
|---|---|
| Example 1 | 0.57 |
| Example 2 | 0.62 |
| Example 3 | 0.56 |
| Comparative Example 1 | 0.33 |
| Comparative Example 2 | 0.43 |
| Comparative Example 3 | 0.39 |
| Floor material for automobile | 0.49 |

It was revealed from a comparison between Examples 1 to 3 and Comparative Examples 1 to 3 that the sound absorption was enhanced when an independent space was formed between a porous material layer constituting a reverse side layer and a porous material layer adjacent thereto.

Further, it was revealed that the sound absorption was further enhanced when the reverse side layer had a depression at the reverse side of the porous material layer constituting the reverse side layer.

### INDUSTRIAL APPLICABILITY

The floor mat of the present invention may be applied to, for example, a use of a floor mat for an automobile.

What is claimed is:

1. A floor mat characterized by consisting of two or more porous material layers, wherein a boundary surface between a porous material layer constituting a reverse side layer and another porous material layer adjacent to the porous material layer is composed of an adhesive surface and a non-adhesive surface, the non-adhesive surface is a non-contact surface, and an independent space is formed between the porous material layer constituting the reverse side layer and the porous material layer adjacent thereto.

2. The floor mat according to claim 1, having a depression at the reverse side of the porous material layer constituting the reverse side layer.

3. A process for manufacturing the floor mat according to claim 1, comprising the steps of:
compressing a porous material between a die having a convex portion to form the independent space, and a flat plane, to thereby obtain a porous material having a concave portion, and
integrating the obtained porous material having a concave portion with another porous material by adhesion of part of a surface to be contacted.

4. A process for manufacturing the floor mat according to claim 2, comprising the steps of:
compressing a porous material between a die having a convex portion to form the independent space, and a die having a convex portion to form the depression at the reverse side of the reverse side layer, to thereby obtain a porous material for the reverse side layer having a concave portion and the depression, and
integrating the obtained porous material for the reverse side layer with another porous material by adhesion of part of a surface to be contacted.
